(19) United States
(12) Patent Application Publication
(10) Pub. No.: US 2004/0226541 A1
(43) Pub. Date: Nov. 18, 2004

(54) No-return loop fuel system

(76) Inventors: Lynwood F. Crary, Preston, CT (US); John R. Forgue, Cheshire, CT (US); Mark R. Johansen, Wallingford, CT (US)

Correspondence Address: William H. Francis, Esq., Reising, Ethington, Barnes, Kisselle, P.C., P.O. Box 4390, Troy, MI, 48099, US

(21) Appl. No.: 10/766,393

(22) Filed: Jan. 28, 2004

Related U.S. Application Data
(63) Continuation-in-part of application No. 10/443,159, filed on May 22, 2003, now abandoned.
(60) Provisional application No. 60/390,377, filed on Jun. 21, 2002.

(51) Int. Cl. F02M 1/00

(52) U.S. Cl. 123/460; 123/457

(57) ABSTRACT

A no-return loop fuel injection system supplies fuel from a turbine-type fuel pump to an injector fuel rail, through a fuel pressure valve assembly capable of flowing supply fuel to the injector rail, and reverse flowing fuel from the rail and back through the pump to relieve rail fuel pressure. Preferably, the pressure valve assembly has a pressure control valve of a diaphragm type which is biased closed via a spring disposed within a reference chamber defined between a housing and a side of the diaphragm and vented to atmosphere. A fuel chamber defined between an opposite side of the diaphragm and a valve body communicates between a pump-side port and a rail-side port. With the valve in a closed position, the fuel chamber is divided into a rail sub-chamber and a pump sub-chamber via the sealing relationship between a valve seat and the diaphragm, held closed by a closure biasing force of the spring. The pressure control valve moves to an open position when the hydraulic force produced by the fuel pressure acting on the fuel chamber side exceeds the closure biasing force of the valve. The fuel hydraulic force is generally calculated as the product of the fuel pressure within the pump-side port times the area of an outer portion of the diaphragm which defines in part the pump sub-chamber, plus the product of the residual fuel pressure within the rail-side port times the area of an inner portion of the diaphragm which defines in part the rail sub-chamber of the fuel chamber. Preferably, the pressure valve assembly also includes a flow check valve orientated in a parallel flow configuration to the pressure control valve to promote starting of the engine during reduced fuel pump output and to eliminate fuel vapor lock within the fuel rail.

### REFERENCE TO RELATED APPLICATION

Applicant claims the benefit of parent non-provisional application Ser. No. 10/443,159, filed May 22, 2003 and published Dec. 25, 2003; which claims the benefit of provisional application Ser. No. 60/390,377, filed Jun. 21, 2002.

### FIELD OF THE INVENTION

This invention relates to automotive engine fuel systems and more particularly to a no-return loop fuel systems having a variable speed fuel pump and a pressure valve assembly.

### BACKGROUND OF THE INVENTION

There are two general types of a no-return loop or returnless fuel injection systems for a combustion engine. The first type, referred to as a “T” configuration, is used in fuel system applications where the fuel pressure within an injector fuel rail is held constant regardless of the mass fuel amount flowing through the injectors. The second type is referred to as a “parallel” configuration and is particularly popular in fuel systems requiring varying fuel pressure within the injector fuel rail dependent upon a particular engine transient. For instance, turbo-charged engines often require injector fuel rail pressures at wide open throttle conditions which are twice that at idle or engine coasting conditions. Both types commonly utilize a cycling or variable speed fuel pump which varies and controls fuel pressure via a pressure signal generated at the fuel rail.

The “T” configuration 10, as best shown in FIG. 1 as prior art, supplies fuel to an injector fuel rail 12 through a flow check valve 14 at the outlet of a variable speed fuel pump 16. The flow check valve 14 will close when fuel pressure at the outlet of the flow check valve exceeds the fuel pressure at the inlet of the flow check valve or pump outlet 18. The flow check valve will typically close when the engine is shut-off, thereby, preventing fuel vaporization and preserving liquid fuel and pressure within the rail 12 for reliable engine start-up. Orientated between the flow check valve and the fuel rail 12 of the “T” configuration 10 is a pressure relief check valve 20 for bleeding fuel directly back to the fuel tank in the event the fuel rail and injectors are subject to an overpressure condition. The pressure relief check valve 20 is designed to typically open when fuel pressure at the fuel rail 12 or inlet 22 of the pressure relief check valve 20 exceeds a predetermined value which is higher than the normal operating pressure at the fuel rail 12. For instance, an overpressure condition may be caused after engine shutdown, wherein the flow check valve 14 is closed and the resultant trapped fuel within the fuel rail 12 rises in pressure with increasing fuel temperature possibly heated by the residual heat emanating from the hot engine or surrounding environment. Yet another scenario of an overpressure condition may be caused by a slow response time of the variable speed pump. For instance, when an engine running at wide open throttle is immediately decelerated into a coasting condition, the injectors may thus close for seconds at a time. This could cause a pressure spike if the variable speed fuel pump can not immediately respond thus the pressure relief check valve will open to relieve fuel pressure at the rail.

Unfortunately, because the pressure relief check valve is referenced to tank pressure as opposed to pump output pressure the relief set pressure of the “T” configuration must be set well above system operating pressure. As a result, the range of pressure control within the fuel rail is limited. A second disadvantage of the “T” configuration is that a separate bypass line and associated fittings are required thus increasing the manufacturing costs and assembly required. The “T” configuration also has a disadvantage of returning fuel overage directly to the fuel tank which may result, particularly under high temperature conditions, in the fuel pump continuously pumping fuel through the pressure relief check valve and back into the fuel tank.

The second or “parallel” configuration, as disclosed in U.S. Pat. No. 5,361,742 (Briggs et al.) and U.S. Pat. No. 5,477,829 (Hassinger et al.), which is probably the most current type of fuel injection system, also utilizes a variable speed fuel pump which varies speed and thus fuel flow based on a fuel pressure input signal from the fuel rail. Unlike the “T” configuration, the “parallel” configuration utilizes a flow check valve and a pressure relief check valve orientated in parallel to one another at the outlet of the pump. During operation of a combustion engine employing the “parallel” configuration of the no-return loop fuel injection system, the flow check valve at the outlet of the fuel pump opens with minimal differential pressure when fuel is supplied to the fuel injector rail, and closes to prevent reverse flow of fuel when the pressure at the flow check valve outlet (or pressure at the rail) is greater than the outlet pressure at the pump (or inlet pressure to the flow check valve). If the pressure at the outlet of the flow check valve exceeds a predetermined value referenced to the outlet of the pump usually during long deceleration periods, the parallel pressure relief check valve will open and fuel will reverse flow through the idle pump. To reduce this excessive fuel pressure at the rail, the normally closed pressure relief check valve opens from a normally closed position while the flow check valve remains closed. The pressure relief setpoint is greater than that of the flow check valve and is typically approximately the minimum value required to operate the engine and keep the fuel in the fuel rail from completely vaporizing during engine shut down. When the pressure relief check valve is open, fuel bleeds back from the fuel rail and through the outlet side of the fuel pump. This “parallel” configuration contrasts with the pressure relief check valve of the “T” configuration where the opening setpoint pressure of the pressure relief check valve is above the maximum running pressure of the fuel rail and the fuel bleed back is not through the fuel pump.

Unfortunately, the parallel combination of the pressure relief check valve and the flow check valve requires many moving parts and thus is expensive to manufacture and maintain. Moreover, both valves are typically of a poppet design. The flow check valve has a ball bearing as a head which engages a seat under its own weight when closed. The pressure relief check valve is similar but typically is assisted by the force of a spring to further bias the ball bearing against the seat. Unfortunately, poppet valves are prone to wear and high frequency pressure fluctuations, as best shown in FIG. 7, which can degrade the smooth running performance of an engine.

### SUMMARY OF THE INVENTION

A no-return loop fuel injection system supplies fuel from a turbine-type fuel pump to an injector fuel rail, through a pressure control valve of a pressure valve assembly capable of flowing supply fuel to the injector rail, and reverse flowing fuel from the rail and back through the pump to relieve rail fuel pressure. Preferably, the pressure control valve has a diaphragm-type valve head biased closed via a spring disposed within a reference chamber defined between a housing and a reference side of the diaphragm and vented to atmosphere. A fuel chamber defined between an opposite fuel side of the diaphragm and a valve body communicates between a pump-side port and a rail-side port. With the control valve in a closed position, the fuel chamber is divided into a rail sub-chamber and a pump sub-chamber via the sealing relationship between a valve seat and the diaphragm, held closed by a closure biasing force of the spring. The valve moves to an open position when the hydraulic force generated by the fuel pressure on the fuel chamber side exceeds the closure biasing force of the valve. The hydraulic force is generally calculated as the product of the fuel pressure within the pump-side port times the area of an outer area of the diaphragm which defines in part the pump sub-chamber, plus the product of the residual fuel pressure within the rail-side port times an inner area of the diaphragm which defines in part the rail sub-chamber of the fuel chamber.

Preferably, the pressure valve assembly also includes an integral flow check valve orientated in a parallel configuration to the pressure control valve. The flow check valve assists in engine starts when battery voltage is lower such as in cold weather and output of the fuel pump is degraded, and prevents vapor lock caused by the cool-down process of a non-running engine. The flow check valve opens upon a relatively small differential pressure to flow fuel from the fuel pump to the injector rail when pump output pressure is less than that required to open the pressure control valve. The flow check valve will also open upon the same differential pressure when the engine and pump are not running and the pressure of trapped fuel within the fuel rail reduces to sub-atmospheric conditions due to cooling, and thus inhibiting fuel vapor lock at the fuel rail.

Preferably, the fuel pump is a variable speed pump which is controlled via a computer receiving an input from a pressure transducer at the rail. Preferably, the closure biasing force is substantially equal to the minimum or idling fuel pressure at the rail times the area of the inner area of the diaphragm.

Objects, features and advantages of this invention are to provide a no-return loop fuel system which utilizes a reverse flowing valve assembly to control fuel pressure delivered to the injectors during various engine operating conditions and preserve fuel pressure within the system at a minimal value during engine shut down. The system avoids supplying excessive fuel to the engine under certain operating conditions, decreases engine emissions, improves engine start during low voltage scenarios, prevents fuel vapor lock at the fuel rail, decreases the number of parts, and is rugged, durable, maintenance free, of relatively simple design and economical manufacture and assembly, and in service has a long useful life.

### DESCRIPTION OF THE DRAWINGS

These and other objects, features and advantages of this invention will be apparent from the following detailed description, appended claims, and accompanying drawings in which:

FIG. 1 is a schematic of a prior art, no-return-loop, “T” configuration, fuel injection system;

FIG. 2 is a schematic of a no-return loop, “parallel” configuration fuel injection system of the present invention;

FIG. 3 is a semi-schematic cross section of a pressure relief valve of the no-return loop fuel injection system shown in an open position;

FIG. 4 is a semi-schematic plan view of the pressure relief valve with portions removed to show internal detail;

FIG. 5 is a semi-schematic cross section of the pressure relief valve similar in perspective to FIG. 3 except the valve is shown in a closed position;

FIG. 6; is a graph of a fuel pressure transient within a fuel rail of the no-return loop fuel injection system utilizing a preferred diaphragm type pressure relief valve;

FIG. 7 is a graph of a fuel pressure transient within a fuel rail of a no-return loop fuel injection system utilizing a poppet-type pressure relief valve;

FIG. 8 is a semi-schematic cross section of the pressure relief valve similar to FIG. 5 except detailing an integral check valve;

FIG. 9 is a perspective view of the pressure relief valve of FIG. 8;

FIG. 10 is a cross section of the pressure relief valve taken along line 10-1 of FIG. 9; and

FIG. 11 is a cross section of the pressure relief valve taken along line 11-11 of FIG. 9.

### DETAILED DESCRIPTION OF THE PREFERRED EMBODIMENTS

As best illustrated in FIG. 2 a no-return loop fuel system 20 of the present invention has a variable speed turbine fuel pump 22 preferably disposed within a fuel tank 24 which delivers fuel to a series of injectors 26 to operatively deliver fuel from a common manifold tube or fuel rail 28 to respective combustion chambers of an engine 23. The speed of the fuel pump 22 is controlled via a computer or a controller 30 (preferably part of the vehicle engine central programming unit) which receives an input signal 32 from a pressure transducer 34 mounted on the fuel rail 28 which then processes the signal and outputs a speed control signal 36 to the pump 22. Preferably, the pressure at the fuel rail 28 varies depending upon engine speed or consumption demand and any other of a variety of engine parameters processed by the controller 30.

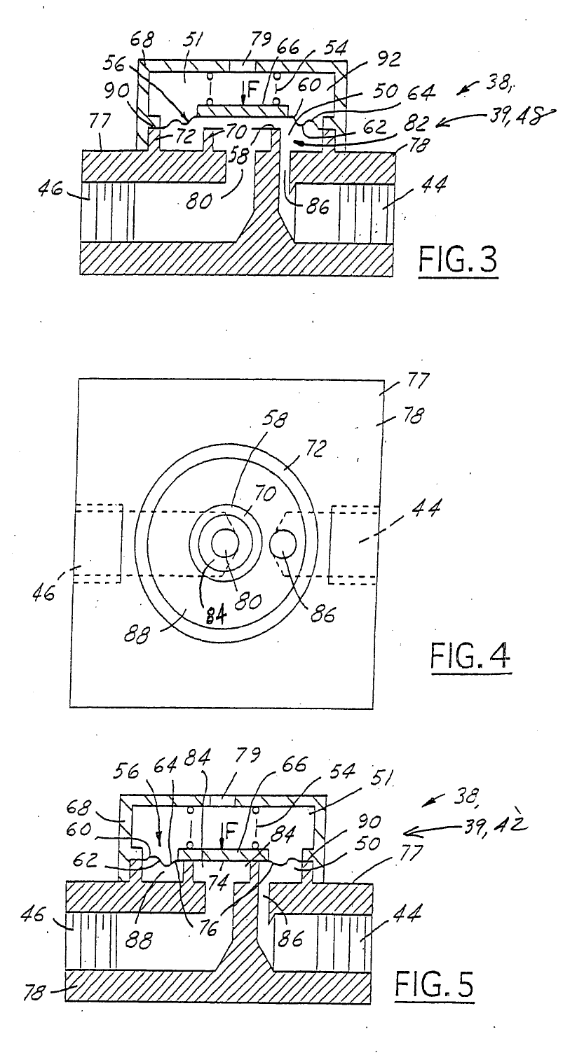

A pressure valve assembly 38 has a pressure relief or control valve 39 interposed in a fuel line 40 communicating between the fuel pump 22 and the engine 23 or fuel rail 28. Pressure relief valve 39 is not a check valve and is capable of fuel flow in either direction, thus a conventional return fuel line for reducing pressure at the rail or any point in-between is not required. When relief valve 39 is in a closed position 42 (FIG. 5), a pump-side passage or port 44 of the pressure valve assembly 38 is generally isolated from an engine-side or rail-side passage or port 46 of the assembly. When the pressure relief valve 38 is in an open position 48 (FIG. 3), fuel may flow in either direction through the valve assembly, depending on the needs of the fuel system 20.

Prior to starting of the engine 23 on a relatively mild temperature day, residual fuel pressure within the fuel rail 28 should be near or substantially below idling pressure, while during engine idle operation the fuel rail 28 idling pressure is controlled by varying the speed of the fuel pump 22. However, any fuel pressure increases of the trapped fuel within the rail caused by residual heat from the engine exhaust manifold or heat generated within the engine compartment, caused for instance by the vehicle standing exposed to the heat of a hot day, is relieved by the pressure relief valve 39 opening to flow fuel from the rail and back through an impeller cavity 25 of the pump 22. To move from the closed to the open positions 42, 48, the force exerted by the residual fuel pressure at the rail-side port 46 must exceed the closure biasing force F of the valve 38 which holds the valve normally closed if the fuel pressure at the pump-side port 44 is at atmospheric or reference pressure. Otherwise, positive residual fuel pressure at the pump-side port 44, even though its less than the residual pressure at the rail-side port 46, will assist to open the valve 38 to relieve fuel pressure at the rail 28. Preferably, the valve 38 is vented to atmosphere or to near atmospheric pressure should the valve 38 be mounted within the fuel tank 24.

Referring to FIGS. 3-5, when the engine 23 is first started, the pump 22 begins to flow supply fuel, and the injectors 26 begin to cycle open. The pump-side port pressure will surge to meet the fuel demand of the cycling open injectors 26. The force exerted by the surging fuel pressure at the pump-side port 44 coupled with the force exerted by the residual fuel pressure at the rail-side port 46, will open the valve 38 once the combined forces exceed the biasing force F of the valve 39. Once the engine 23 is started, and with the fuel relief valve 39 open, the speed of the pump 22 will adjust or level-off to maintain idling or minimum fuel pressure at the rail 28 assuming the engine is at idling condition.

For enhanced fuel systems, during start-up, the fuel injectors 26 will not begin to cycle open until the fuel pressure within the fuel rail reaches minimum idling pressure. Therefore, the pump 22 will initiate first, and the injectors 26 will only cycle open after idle operating pressure is reached at the rail 28. This sequencing is especially preferable when hot trapped fuel within the rail 28 has been relieved of pressure through the fuel relief valve 38 to idling pressure and then the fuel cools dropping further in pressure to a reduced residual pressure, well below necessary idling pressure, thus requiring more time for the pump 22 to restore fuel pressure to idle operation levels before injector cycling. Any fuel leakage through the injectors can only aggravate this condition by dropping the residual pressure even further. In any event, the residual fuel pressure within the rail 28 theoretically remains high enough to prevent the vaporization of fuel or air ingress into the fuel rail which could hinder start-up and cause rough idling conditions. Similarly, for enhanced fuel systems, during start-up, the area of the valve 39 which communicates with the rail 28 and the area of the valve 39 that communicates with the pump 22 can be sized and the biasing force F can be specified such that the fuel pressure maintained in the fuel rail when the engine 23 is off is equal to or higher than operating pressure. This condition minimizes the generation of vapor in the fuel rail 28 during hot engine off conditions.

Preferably, as the engine speed increases, fuel flow increases and the required fuel pressure within the fuel rail 28 increases. This increase in pressure is especially true for turbo-charged engines where the rail pressure at wide open throttle conditions is typically approximately twice the required rail pressure at idle. When an engine is running at wide open throttle conditions and is suddenly decelerated to a coasting engine condition, the injectors 26 may remain suddenly closed for seconds at a time. Although the fuel pump 22 may effectively stop, high fuel pressures within the rail must still be relieved to substantially reduce rail pressure to idling pressures. Excessive heat from the engine 23 will aggravate this overpressure condition. Therefore, fuel must flow from the rail through the open pressure relief valve 39 of the pressure valve assembly 38, and back through the impeller cavity 25 of the idle pump 22. The reaction time for this pressure drop scenario is quick because the pressure relief valve 39 is believed to never actually close from its open position 48 during the wide open throttle condition of the engine. That is, the force exerted by the fuel pressure at the pump-side port 44 plus the force generated by the fuel pressure at the rail-side port 46 never drops below the closure biasing force F of the valve 39, which as previously described is substantially near the necessary fuel idling pressure at the rail.

When the engine 23 is shut down, the injectors 26 stop cycling open and the pump stops. The pressure relief valve 39 remains in its open position 48 until the force exerted by the fuel pressure at the rail-side port 46 equals or is slightly less than the closure biasing force F of the pressure relief valve 39 at which point the valve moves to the closed position 42. This assumes the fuel pressure at the pump-side port 44 drops to substantially atmospheric pressure and the valve 39 is vented to atmosphere.

Referring to FIGS. 3-6, the ports 44, 46 communicate with each other via an interposing cylindrical fuel chamber 50 defined generally between a body 78 of the valve 38 and a valve head or resilient diaphragm assembly 56 when the valve is in the open position 48. Preferably, the pressure relief valve 39 is passive and biased in the closed position 42 by a spring 54 having a known coefficient of compression or spring constant thus exerting a known force upon the diaphragm assembly 56 which sealably engages to a valve seat 58.

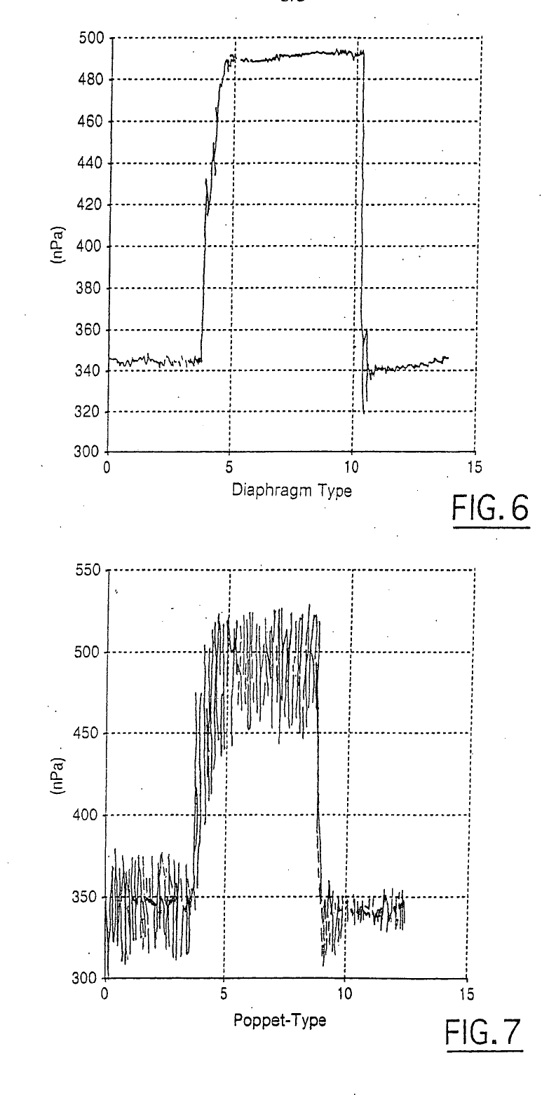

The valve head 56 may take the form of a poppet-type or ball bearing head. However, as shown in FIG. 7, poppet valves tend to oscillate excessively creating pressure spikes within the fuel rail which could degrade smooth running performance of an engine. In contrast, the performance of the preferred diaphragm type valve 38, as shown in FIG. 6, has a much smoother yet equally responsive performance curve. As opposed to poppet valve designs which are always moving, causing oscillations in fuel pressure at the rail, the diaphragm design relieves these transients creating a smoother running engine, with less noise and less wear.

The valve head 56 has a resilient diaphragm 60 having a fuel side 62 and a reference side 64. The fuel chamber 50 is defined between the valve body 78 which carries the ports 44, 46 and the fuel side 62 of the diaphragm 60, and a reference chamber 51 is defined between the reference side 64 of the diaphragm 60 and a housing 68. Preferably, a substantially rigid member 66 is engaged to the reference side 64 of the diaphragm 60 to support the spring 54 which is compressed axially or biased between the valve housing 68 and the rigid member 66 within the reference chamber 51. The spring 54 assures reliable seating of the diaphragm 60 against the valve seat 58.

The valve seat 58 is substantially annular in shape and is carried by the rim or distal end of an inner shoulder 70 projecting upward from a surface 77 of the valve body 78. An outer shoulder 72 is concentric to and disposed radially outward from the inner shoulder 70 and sealably engages both the housing 68 and a peripheral edge 90 of the diaphragm 60.

An inner orifice 80 carried by the surface 77 of the body 78 communicates between the fuel chamber 82, defined by the surface 77 and the fuel side 62 of the diaphragm 60, and the rail-side port 46. When the relief valve 39 is in the closed position 42, the inner orifice 80 communicates solely with a substantially cylindrical rail sub-chamber 84 of the fuel chamber 82 which is defined in part by a substantially circular first area or inner portion 74 of the fuel side 62 of the diaphragm 60 and a substantially circular portion of the surface 77 of the body 78 disposed radially inward from the inner shoulder 70. An outer orifice 86 carried by an annular portion of the surface 77 disposed radially between the shoulders 70, 72 of the body 78 communicates between a pump sub-chamber 88 of the fuel chamber 82 disposed radially outward from the rail sub-chamber 84 and segregated therefrom by the inner shoulder 70 or seat 58. The pump sub-chamber 88 is defined in-part by the substantially annular shaped second area or outer portion 76 of the fuel-side 62 of the diaphragm 60 and the annular portion of the surface 77 of the body disposed radially between the shoulders 70, 72.

For the valve 39 to open, the total hydraulic force exerted on the fuel-side 62 of the diaphragm 60 must be greater than the total closure biasing force F exerted on the reference side 64 which is substantially the spring force (produced by spring 54) plus that force generated by the air pressure within the reference chamber 51. Preferably, the reference chamber 51 is vented to atmosphere via the orifice 79 carried by the housing 68, so that the closure biasing force F is substantially the spring force alone. However, the reference chamber 51 can be vented to other areas such as the vacuum manifold, the fuel tank, or the inlet to the fuel pump to vary the pressure in chamber 51 which could potentially correlate the valve operation with varying dynamics of the engine.

Assuming the reference chamber 51 is vented to atmosphere and the engine 23 is shut off so that the pump-side port 44 is substantially at atmospheric pressure, the pressure relief valve 39 will remain in the normally closed position 42 unless the biasing force F is exceeded by the hydraulic force calculated generally as the residual fuel pressure within the fuel rail 28 or rail-side port 46 times the exposed or circular area 74. Once the hydraulic force exceeds the biasing force F, the valve 39 will initially crack open to relieve pressure until once again the hydraulic force decreases to slightly below the closure biasing force F.

During engine start-up, the pressure relief valve 39 will remain in its normally closed position 42 until the biasing force F is exceeded by the opposing hydraulic force which is generally calculated as the summation of the product of the residual pressure at rail-side port 46 times the area of the circular area 74 plus the product of the fuel pressure at the pump-side port 44 times the area of the annular area 76. Once the hydraulic force exceeds the biasing or spring force F, the valve 38 will initially open. The valve will then remain open provided the hydraulic pressure calculated as the fuel pressure within the fuel chamber 50 times the total area of the fuel side 62 of the diaphragm 60 remains in excess of the closure biasing force F.

During design, the size of inner area 74, or the ratio of area 74 over the total exposed area of diaphragm side 62 must be sized in comparison to the closure biasing force F so that the valve 38 will open if the rail pressure exceeds minimum idling pressure. Moreover, area 74 exposed generally to the rail-side port 46 is smaller than area 76 exposed generally to the pump-side port 44. This means during start-up of the engine 23, and after a long shutdown period, so that residual pressure at the rail is near zero or atmospheric, it takes less pressure to open the valve 39 to supply fuel to the rail 28, than it takes to open the valve 39 to relieve residual pressure from the rail 28 flowing fuel back to the idle pump 22.

When the engine 23 is running at wide open throttle conditions, the cycling fuel injectors 26 can, for the sake of example, require a fuel rail pressure of 500 kPa. Should the operator suddenly decelerate, the fuel injectors 26 will shut-off otherwise trapping fuel in the rail 28 at about 500 kPa, if it were not for valve 39 which remains open, when the engine injectors 26 actually want about 200 kPa for idling operation. Because the pressure relief valve 39 remains open, fuel from the rail 28 can reverse flow back through the pump 22 to immediately relieve pressure. This immediate reduction in pressure at the rail enhances injector calibration by increasing the injector pulse width.

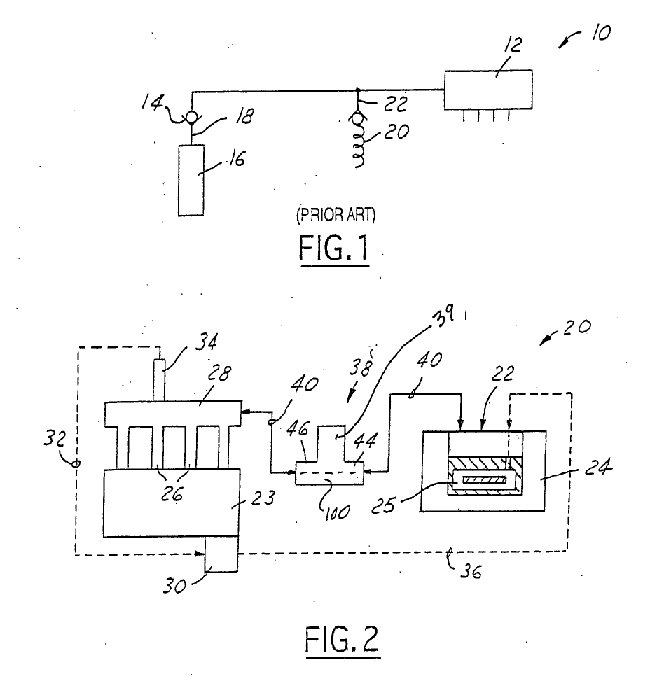

For a turbo-charged engine system operating under variable pressure conditions, required fuel rail pressure at wide open throttle can be five bars while desired engine idling pressure at the fuel rail is two and a half bars. Conventional, no-return loop, “T” configuration, fuel injection systems as shown in FIG. 1, require the pressure relief check valve 20 to actuate above five bars. The pressure relief valve 39 of the no-return loop, “parallel” configuration, fuel injection system 20 requires a pressure relief valve 39 setting of only two and a half bars to flow fuel even in the relief or reverse direction. Therefore, when the engine 23 is shut down, fuel rail pressure immediately falls to two and a half bars as opposed to holding at five bars for the prior art system which would therefore be more prone to fuel leakage through the injectors and unwanted rich engine start scenarios. Regardless, the pressure relief valve 39 of the present invention can replace the flow check valve 14 at the outlet 18 of the pump 16 of a conventional “T” configuration fuel injection system 10. With this application, the fuel rail of the “T” configuration system need not be exposed to high internal fuel pressures when the engine is shut down. This has the benefit of reducing the likelihood of injector fuel leakage.

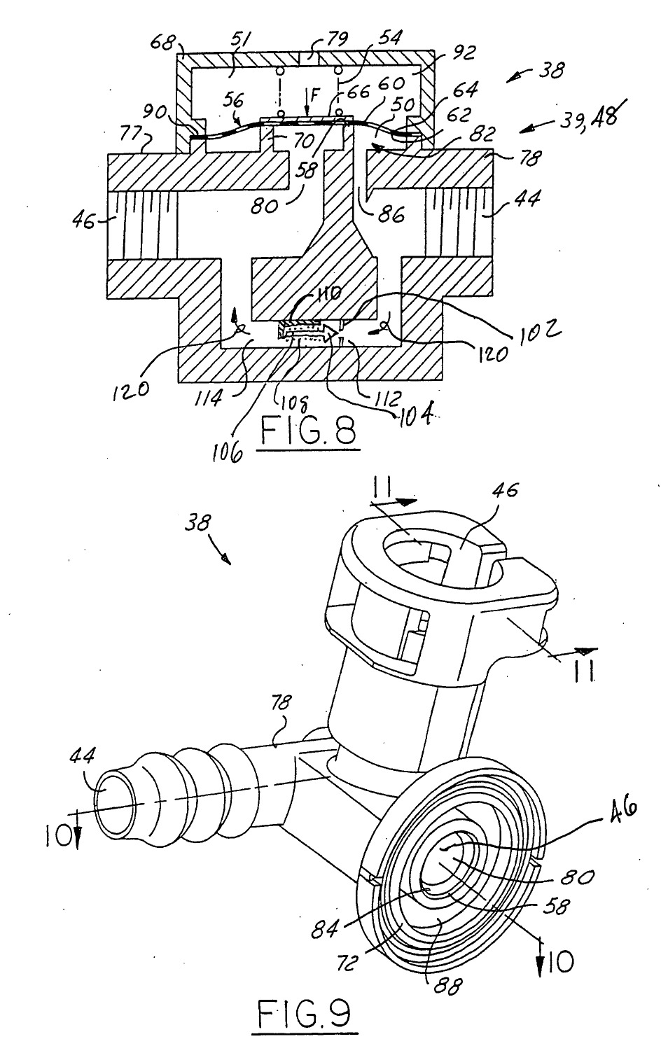

In an ideal engine application, the pressure valve assembly 38 will operate sufficiently as previously described with only the pressure relief or control valve 39. However, in selected engine applications requiring a more robust design such as those exposed to extreme weather or temperature conditions which could significantly decrease battery voltage levels or cause vapor lock within the fuel rail 28 a check valve 100 is preferably integrated into the pressure valve assembly 38, as best illustrated in FIGS. 8-11. The check valve 100 is orientated to bypass the pressure relief valve 39 allowing fuel to flow from the pump-side port 44 to the rail-side port 46 when the fuel pump 22 is running at reduced output levels due to low voltage and is thus not capable of producing sufficient pressure to open the pressure relief valve 39 or when the fuel pump 22 is not running and due to cold weather conditions a predetermined vacuum pressure develops in the fuel rail 28.

Unlike the diaphragm-type pressure relief valve 39, the check valve 100 is preferably a poppet or ball-type valve having a compression spring 108 which produces a biasing force to hold the valve 100 normally closed. This biasing force is appreciably less than the biasing force of the compression spring 54 which holds the pressure relief valve 39 closed. For example, during start-up, if the engine 23 requires 200 kPa at the rail 28 to operate at idle, the pump is required to produce a fuel pressure substantially near 200 kPa (not differential pressure) against the annular second area 76 of the diaphragm assembly 60 to open the pressure relief valve 39. This assumes that the fuel rail pressure exposed to the first area 74 of the diaphragm 60 is substantially near atmospheric, as is the reference chamber 51 thus providing little to no assistance in opening the relief valve 39. In contrast, opening of the check valve 100 requires a differential pressure of only about 20 kPa to open. Thus, if the fuel rail pressure is at atmospheric, the flow check valve 100 will open when the fuel pressure in the pump-side channel 44 reaches 20 kPa. Consequently, even if the pressure relief valve 39 fails to open, the fuel flow through the check valve 100 is sufficient to start the engine 23 during low voltage conditions, thus raising operating voltage levels, which then improves the output of the fuel pump 22 and raises fuel pressure levels to open the pressure relief valve 39 for continuing engine operation. Once the pressure relief valve 39 opens, the pressure in the fuel rail 28 increases to substantially the fuel pressure in the pump-side channel or port 44. The differential pressure across the check valve 100 thus falls below 20 kPa and the check valve 100 closes while the pressure relief valve 39 remains open.

During normal engine start operation, when voltage levels are not significantly decreased and pump output is within normal range, fuel pressure within the pump-side channel 44 will quickly increase to the fuel pressure level needed for engine idling operation and opening of the pressure relief valve 39. During this brief pressure ramping period, the flow check valve 100 may briefly flutter open-and-close but will not significantly contribute toward engine start. Any fuel flow entering the fuel rail 28 via the fluttering check valve 100 will only contribute toward opening of the pressure relief valve 39 by raising fuel pressure within the fuel rail which in-turn exerts a positive pressure against the first area 74 of the fuel side 62 of the diaphragm 60.

The check valve 100 also prevents unwanted fuel vapor lock at the rail 28 during cooling weather and/or declining temperature conditions within the engine compartment which could hinder engine start, lead to rough idling of the engine 23, or simply induce a vacuum against the circular first area 74 of the diaphragm 60 making it more difficult for the pump 22 to open the pressure relief valve 39. For instance, when a hot idling engine is shut down there exists a hot soak period typically of five to ten minutes wherein external temperatures at the fuel rail 28 can further elevate due to residual heat emitted from surrounding heat sinks such as the exhaust manifold. Fuel temperature rises even further within the fuel rail 28, the trapped fuel increases in pressure until the pressure relief valve 39 opens briefly to relieve rail pressure. After the soak period has expired and the engine cools, and especially if external weather temperatures should fall to cooler conditions, the pressure of the trapped fuel in the rail 28 could conceivably fall below atmospheric exerting a vacuum upon the tightly closed diaphragm 60 of the relief valve 39. When starting the engine under this condition, the vacuum pressure of the rail must be overcome by the fuel pump 22 before the pressure relief valve 39 will open. Moreover, the sub-atmospheric pressure within the rail 28 will lower the liquid-to-vapor transition point of the trapped fuel tending toward unwanted vapor lock.

Incorporating the check valve 100 into the pressure valve assembly 38 addresses the above mentioned issues with vacuum pressure development in the fuel rail 28. For instance, assuming the fuel pressure at the pump 22 and port 44 is atmospheric with the engine shut down, if pressure within the rail 28 drops below a predetermined value, such as a negative 20 kPa as in the above example, the check valve 100 will open to expose the rail 28 to the atmospheric pressure of the port 44. Consequently, the pressure relief valve 39 is never exposed to a vacuum of greater than the predetermined value, or 20 kPa, and the transition point is never adversely effected to such a degree that it would cause vapor lock in the fuel rail 28.

Consequently and per the above discussed example, during engine start the fuel pump 22 must produce a fuel pressure in the port or channel 44 of slightly over 200 kPa to compensate for the slight vacuum in the fuel rail 28. More specifically, assuming the reference chamber 51 is exposed to atmospheric pressure and fluttering of the check valve 100 is insignificant, the force exerted upon the fuel side 62 of the diaphragm 60 must exceed the biasing force of the spring 54 exerted upon the reference side of the diaphragm to open the pressure relief valve 39. With a vacuum on the rail-side (minimized by the check valve 100) the force necessary to open the pressure relief valve 39 is generally the summation of the product of the diaphragm area of the second or outer area 76 times the fuel pressure in the port 44, minus the product of the diaphragm area of the second or inner area 74 times the absolute fuel vacuum pressure in the port 46 or fuel rail 28.

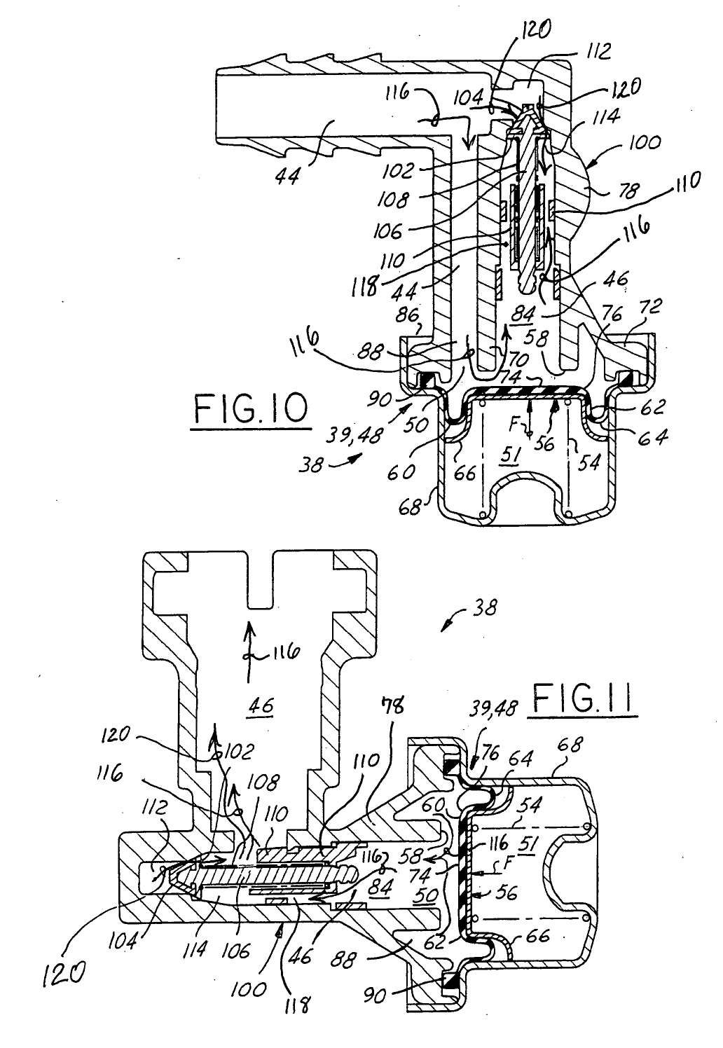

Referring to FIGS. 10 and 11, a generally annular valve seat 102 of the poppet check valve 100 is carried by the fuel resistant plastic body 78 of the pressure valve assembly 38. A metallic, forward tapered, enlarged head 104 of the check valve 100 is disposed concentrically at one end of an elongated metallic stem 106 and is held sealably against the seat 102 by the compression spring 108 which exerts a predetermined biasing force against a rearward annular surface of the head 104 to hold or bias the check valve 100 closed. The spring 108 is received about the stem 106 and is compressed axially between the enlarged head 104 and a body section 110 engaged rigidly to the body 78 of the pressure valve assembly 38 in the rail-side channel or port 46. The body 78 defines an inlet passage 112 which tees off of a mid-point of the pump-side channel 44 and leads to the valve head 104 and rearward facing seat 102. When the check valve 100 is open, an outlet passage 114 communicates with the inlet passage 112 and tees into a mid-point of the rail-side channel 46. The valve head 104 is generally disposed in the passages 112, 114 and the valve stem 106 projects from the head 104 well into the rail-side channel 46 and terminates short of the rail sub-chamber 84.

Referring to FIGS. 10 and 11, the check valve 100 is shown closed and the pressure relief valve 39 is in an open position 48, thus generally illustrating an engine starting, steady state running, or engine accelerating condition or configuration. In this configuration, fuel flows in the direction of arrows 116 through the L-shaped pump-side port 44 (not shown in FIG. 11), into the fuel chamber 50, then into the L-shaped rail-side port 46, flowing through voids 118 of the port 46 which are formed generally by the body section 110 and stem 106 of the flow check valve 100, then taking an approximate ninety degree bend to continue flowing through the port 46 (which turns into a direction outward from the page in FIG. 10 and upward in FIG. 11) to the fuel rail 28. As previously described, if the fuel rail 28 requires pressure relief, possibly during an abrupt deceleration, the pressure relief valve 39 remains open and fuel flow reverses flowing along the same path but in a direction opposite to arrow 116. When the pressure relief valve 39 is closed and the flow check valve 100 is open, fuel flows in the direction of arrow 120, partially along port 44, diverting into inlet passage 112, flowing past the unseated (not shown) head 104 into outlet passage 114, diverting into the ninety degree bend of port 46 and flowing (generally upward from the page) to the fuel rail 28. Unlike the pressure relief valve 39, the flow check valve 100 does not provide a reverse flow path.

While the forms of the invention herein disclosed constitute a presently preferred embodiment, many others are possible. For instance, the pressure relief valve can be replaced with a servo or pneumatic controlled valve which operates via the controller and pressure signals received from the transducer at the rail and an additional transducer positioned at the outlet of the fuel pump. It is not intended herein to mention all the possible equivalent forms or ramification of the invention. It is understood that terms used herein are merely descriptive, rather than limiting, and that various changes may be made without departing from the spirit or scope of the invention.

1. A pressure valve assembly for a no-return loop fuel delivery system having a fuel injector for operatively flowing fuel into a combustion engine and a fuel pump for flowing pressurized fuel to the injector through the pressure valve assembly, the pressure valve assembly comprising:
a body;
a pump-side port carried by the body;
an engine-side port carried by the body, wherein the pump-side port is positioned between the fuel pump and the engine-side port, the engine-side port being positioned between the pump-side port and the fuel injector;
a valve seat carried by the body and disposed between the engine-side and pump-side ports; and
a valve head biased sealably against the valve seat when the valve assembly is in a closed position, the valve head having a first area exposed to the pump-side port and a second area exposed to the engine-side port.

2. The pressure valve assembly set forth in claim 1 wherein the valve head is biased against the valve seat by a spring.

3. The pressure valve assembly set forth in claim 1 comprising:
a housing engaged to the body; and
a reference chamber defined between the valve head and the housing, the reference chamber being isolated from the engine-side and pump-side ports regardless of whether the valve assembly is in the closed or an open position.

4. The pressure valve assembly set forth in claim 3 wherein the valve head has a resilient diaphragm having a peripheral edge engaged sealably to the body.

5. The pressure valve assembly set forth in claim 4 comprising:
a fuel chamber defined between the body and the diaphragm; and
wherein the engine-side port communicates with the pump-side port via the fuel chamber when the pressure valve assembly is in the open position, and wherein the diaphragm obstructs communication between the engine-side port and the pump-side port at the fuel chamber when the valve is in the closed position.

6. The pressure valve assembly set forth in claim 5 comprising a spring disposed within the reference chamber and compressed resiliently between the diaphragm and the housing.

7. The pressure valve assembly set forth in claim 6 wherein the reference chamber is vented to atmospheric pressure.

8. A no-return loop fuel delivery system for a combustion engine comprising:
a fuel pump;
a fuel rail assembly having a fuel injector for injecting fuel into the combustion engine;
a pressure control valve constructed and arranged to flow fuel between the fuel rail assembly and the fuel pump, the pressure regulator valve having a pump-side port, a rail-side port, an open position, a closed position, and a closure biasing force, the pump-side port being positioned between the fuel pump and the rail-side port, the rail-side port being positioned between the pump-side port and the fuel rail;
wherein the pressure control valve moves from the closed position to the open position to flow fuel from the fuel pump through the ports and to the fuel rail when the closure biasing force is exceeded by an opposing hydraulic force generated by fuel pressure; and
wherein the pressure control valve moves from the closed position to the open position to flow fuel from the fuel rail through the ports and back through the fuel pump when the closure biasing force is exceeded by the opposing hydraulic force generated by fuel pressure.

9. The no-return loop fuel delivery system set forth in claim 8 wherein a one-way flow check valve is not constructed and arranged to operate between the fuel rail assembly and the fuel pump.

10. The no-return loop fuel delivery system set forth in claim 8 wherein the fuel pump is a variable speed fuel pump.

11. The no-return loop fuel delivery system set forth in claim 10 comprising:
a pressure transducer for measuring fuel pressure within the fuel rail assembly; and
a controller for receiving and processing a pressure signal from the pressure transducer and sending a speed command signal to the variable speed fuel pump.

12. The no-return loop fuel delivery system set forth in claim 8 wherein the pressure control valve comprises:
a body;
a resilient diaphragm having a peripheral edge engaged sealably to the body;
a fuel chamber defined between the body and the diaphragm;
a rail-side port carried by the body and communicating with the fuel chamber;
a pump-side port carried by the body and communicating with the chamber; and
wherein the rail-side port communicates with the pump-side port via the fuel chamber when the pressure control valve is in the open position, and wherein the diaphragm obstructs communication between the rail-side port and the pump-side port via the fuel chamber when the pressure control valve is in the closed position.

13. The no-return loop fuel delivery system set forth in claim 12 comprising:
a housing engaged sealably to the peripheral edge of the diaphragm and the body;
a reference chamber defined between the housing and a reference side of the diaphragm; and
wherein the fuel chamber is defined between an opposite fuel side of the diaphragm and the body.

14. The no-return loop fuel delivery system set forth in claim 13 comprising:
a valve seat exposed within the fuel chamber and seated sealably against the fuel side of the diaphragm when the pressure control valve is in the closed position;
wherein the fuel side of the diaphragm has a first area and a second area;
a pump sub-chamber of the fuel chamber defined between the body and the first area of the diaphragm; and
a rail sub-chamber of the fuel chamber defined between the body and the second area of the diaphragm, wherein the rail sub-chamber is isolated from the pump sub-chamber when the diaphragm sealably contacts the valve seat.

15. The no-return loop fuel delivery system set forth in claim 14 wherein the reference chamber is vented to atmospheric pressure.

16. The no-return loop fuel delivery system set forth in claim 14 wherein the valve seat is annular in shape and the rail sub-chamber is disposed radially inward of the valve seat.

17. The no-return loop fuel delivery system set forth in claim 16 wherein the body has a cylindrical shoulder disposed within the fuel chamber and carrying the annular valve seat.

18. A pressure valve assembly for a no-return loop fuel delivery system having a fuel injector for operatively flowing fuel into a combustion engine and a fuel pump for flowing pressurized fuel to the injector through the pressure valve assembly, the pressure valve assembly comprising;
a body;
a biased closed pressure relief valve carried by the body;
a flow check valve carried by the body and orientated in a parallel flow configuration with the pressure relief valve;
a pump-side channel defined by the body and communicating with the pump;
an engine-side channel defined by the body and communicating between the fuel injector and the pump-side channel when the pressure relief valve is open;
wherein the fuel injector communicates with the pump via the communication of the pump-side channel with the engine-side channel when the pressure relief valve is open;
an inlet passage defined by the body and communicating with the pump;
an outlet passage defined by the body and communicating with the fuel injector; and
wherein the fuel injector communicates with the pump via the communication of the inlet passage with the outlet passage when the flow check valve is open.

19. The pressure valve assembly set forth in claim 18 comprising:
a valve seat of the pressure relief valve carried by the body and disposed between the engine-side and pump-side channels;
a valve head of the pressure relief valve having a fuel side biased sealably against the valve seat when the pressure relief valve is in a closed position and a reference side exposed to atmospheric pressure, the fuel side having a first area exposed to the pump-side channel and a second area exposed to the engine-side channel; and
wherein the pressure relief valve will move from the closed position to an open position when a predetermined force is exceeded and generally measured by the product of area of the first area times fuel pressure within the rail-side channel plus the product of area of the second area times fuel pressure within the pump-side channel.

20. The pressure valve assembly set forth in claim 19 wherein the flow check valve is constructed and arranged to open when fuel pressure in the inlet passage exceeds fuel pressure in the outlet passage by a predetermined pressure differential.

21. The pressure valve assembly set forth in claim 20 wherein the predetermined pressure differential of the flow check valve is substantially less than a predetermined pressure exposed at the second area of the fuel side of the valve head of the pressure relief valve and the reference side of the valve head of the pressure relief valve is exposed to atmospheric pressure.

22. The pressure valve assembly set forth in claim 21 wherein the head of the pressure relief valve has a diaphragm which carries the fuel and reference sides.

23. The pressure valve assembly set forth in claim 22 wherein the pressure relief valve and the flow check valve are each biased closed by compression springs.

24. The pressure valve assembly set forth in claim 21 wherein the pressure needed to open the pressure relief valve and to the second area of the fuel side of the valve head of the pressure relief valve when the reference pressure and the fuel pressure at the injector are at atmospheric pressure is substantially near the operating pressure of the fuel injector when the engine is operating at idle conditions.

25. The pressure valve assembly set forth in claim 23 wherein the flow check valve is a poppet valve.

26. The pressure valve assembly set forth in claim 23 wherein the flow check valve is a ball valve.

27. A no-return loop fuel delivery system for a combustion engine comprising:
a variable speed fuel pump;
a fuel rail connected to a fuel injector for injecting fuel into the combustion engine;
a pressure relief valve having a valve head having a reference side exposed to a reference pressure and a fuel side having a first area exposed to the fuel rail and a second area exposed to the fuel pump when the pressure relief valve is in a closed position; and
wherein the pressure relief valve moves to an open position for flowing fuel in either direction between the fuel pump and the fuel rail when the fuel pressure exposed to the second area of the fuel side of the valve head exceeds slightly less than the operating fuel idle pressure of the engine when the pressure relief valve is closed and the reference side is exposed to reference pressure and the fuel pressure in the fuel rail is at substantially near reference pressure.

28. The no-return loop fuel delivery system set forth in claim 27 comprising:
a biased closed flow check valve orientated between the fuel rail and the fuel pump for bypassing fuel flow around the pressure relief valve; and
wherein the check valve is constructed and arranged to open when fuel pressure at the fuel pump exceeds fuel pressure at the fuel rail by a predetermined pressure differential.

29. The no-return loop fuel delivery system set forth in claim 28 comprising:
a resilient diaphragm of the valve head of the pressure relief valve carrying the fuel side and reference side; and
a compression spring bearing upon the reference side for biasing the pressure relief valve in the closed position.

30. The no-return loop fuel delivery system set forth in claim 29 wherein the check valve is a spring biased poppet valve.

31. The no-return loop fuel delivery system set forth in claim 30 wherein the pressure relief valve will move from the closed position to an open position when a predetermined force exerted by the spring of the pressure relief valve plus the product of area of the reference side times the reference pressure, is exceeded by the product of area of the first area times fuel pressure at the rail plus the product of area of the second area times fuel pressure at the pump.

32. The no-return loop fuel delivery system set forth in claim 31 wherein the predetermined pressure differential of the check valve is substantially less than a predetermined pressure differential across the second area of the fuel side of the diaphragm and the reference side of the diaphragm.

33. The no-return loop fuel delivery system set forth in claim 31 wherein the pressure differential across the second area of the fuel side of the diaphragm and the reference side of the diaphragm is substantially near the operating pressure of the fuel injector when the engine is operating at idle conditions.

34. The no-return loop fuel delivery system set forth in claim 17 comprising a flow check valve orientated in a parallel flow configuration with the pressure control valve for flowing fuel from the fuel pump to the fuel rail when a predetermined fuel pressure differential across the flow control valve is reach and the pressure control valve is in the closed position.

35. A no-return loop fuel delivery system for a combustion engine comprising:
a fuel pump;
a fuel rail assembly having a fuel injector for injecting fuel into the combustion engine;
a pressure regulator valve constructed and arranged to flow fuel between the fuel rail assembly and the fuel pump, the pressure regulator valve having a pump-side port, a rail-side port, an open position, a closed position, and a closure biasing force, the pump-side port being positioned between the fuel pump and the rail-side port, the rail-side port being positioned between the pump-side port and the fuel rail;
wherein the pressure regulator valve moves from the closed position to the open position to flow fuel from the fuel pump through the ports and to the fuel rail when the closure biasing force is exceeded by an opposing hydraulic force generated by fuel pressure;
wherein the pressure regulator valve moves from the closed position to the open position to flow fuel from the fuel rail through the ports and back through the fuel pump when the closure biasing force is exceeded by the opposing hydraulic force generated by fuel pressure; and
wherein a one-way flow check valve is not constructed and arranged to operate between the fuel rail assembly and the fuel pump.

36. The no-return loop fuel delivery system set forth in claim 35 wherein the fuel pump is a variable speed fuel pump.

37. The no-return loop fuel delivery system set forth in claim 36 comprising:
a pressure transducer for measuring fuel pressure within the fuel rail assembly; and
a controller for receiving and processing a pressure signal from the pressure transducer and sending a speed command signal to the variable speed fuel pump.

38. The no-return loop fuel delivery system set forth in claim 35 wherein the pressure regulator valve is of a diaphragm-type.

39. The no-return loop fuel delivery system set forth in claim 38 wherein the pressure regulator valve comprises:
a body;
a resilient diaphragm having a peripheral edge engaged sealably to the body;
a fuel chamber defined between the body and the diaphragm;
a rail-side port carried by the body and communicating with the fuel chamber;
a pump-side port carried by the body and communicating with the chamber; and
wherein the rail-side port communicates with the pump-side port when the regulator valve is in the open position, and wherein the diaphragm obstructs communication between the rail-side port and the pump-side port within the fuel chamber when the valve is in the closed position.

40. The no-return loop fuel delivery system set forth in claim 39 comprising:
a housing engaged sealably to the peripheral edge of the diaphragm and the body;
a reference chamber defined between the housing and a reference side of the diaphragm; and
wherein the fuel chamber is defined between an opposite fuel side of the diaphragm and the body.

41. The no-return loop fuel delivery system set forth in claim 40 comprising:
a spring disposed within the reference chamber and compressed resiliently between the diaphragm and the housing; and
wherein the closure biasing force is the force of the spring plus the product of the reference chamber pressure times the area of the exposed reference side of the diaphragm.

42. The no-return loop fuel delivery system set forth in claim 41 comprising:
a valve seat exposed within the fuel chamber and seated sealably against the fuel side of the diaphragm when the pressure regulator valve is in the closed position;
the fuel side of the diaphragm having a first area and a second area;
a pump sub-chamber of the fuel chamber defined between the body and the first area of the diaphragm; and
a rail sub-chamber of the fuel chamber defined between the body and the second area of the diaphragm, wherein the rail sub-chamber is isolated from the pump sub-chamber when the valve seat is engaged to the diaphragm.

43. The no-return loop fuel delivery system set forth in claim 42 wherein the reference chamber is vented to atmospheric pressure.

44. The no-return loop fuel delivery system set forth in claim 42 wherein the first area is larger than the second area.

45. The no-return loop fuel delivery system set forth in claim 42 wherein the valve seat is annular in shape and the rail sub-chamber is disposed radially inward of the valve seat.

46. The no-return loop fuel delivery system set forth in claim 45 wherein the body has a cylindrical shoulder disposed within the fuel chamber and carrying the annular valve seat.

47. A pressure regulator valve for a no-return loop fuel delivery system having a fuel injector for operatively flowing fuel into a combustion engine and a fuel pump for flowing pressurized fuel to the injector through the pressure regulator valve, the pressure regulator valve comprising:
a body;
a pump-side port carried by the body;
an engine-side port carried by the body, wherein the pump-side port is positioned between the fuel pump and the engine-side port, the engine-side port being positioned between the pump-side port and the fuel injector;
a valve seat carried by the body and disposed between the engine-side and pump-side ports;
a valve head biased sealably against the valve seat when the valve is in a closed position thereby isolating the engine-side port from the pump-side port, the valve head having a first area exposed to the pump-side port and a second area exposed to the engine-side port;
a housing engaged to the body; and
a reference chamber defined at least in part by the valve head and the housing, the reference chamber being isolated from the engine-side and pump-side ports regardless of whether the valve is in the closed or open position.

48. The pressure regulator valve set forth in claim 47 wherein the valve head is biased against the valve seat by a spring.

49. The pressure regulator valve set forth in claim 47 wherein the valve head has a resilient diaphragm having a peripheral edge engaged sealably to the body.

50. The pressure regulator valve set forth in claim 49 comprising:
a fuel chamber defined between the body and the diaphragm; and
wherein the engine-side port communicates with the pump-side port via the fuel chamber when the regulator valve is in the open position, and wherein the diaphragm obstructs communication between the engine-side port and the pump-side port within the fuel chamber when the valve is in the closed position.

51. The pressure regulator valve set forth in claim 50 comprising a spring disposed within the reference chamber and compressed resiliently between the diaphragm and the housing.

52. The pressure regulator valve set forth in claim 51 wherein the reference chamber is vented to atmospheric pressure.

53. A pressure control valve for a fuel delivery system having a fuel injector for operatively flowing fuel into a combustion engine and a fuel pump for flowing pressurized fuel to the pressure control valve and the injector, the pressure control valve comprising:
a body;
a first port carried by the body;
a second port carried by the body and orientated communicatively between the fuel injector and the second port;
a valve seat carried by the body and disposed between the first and second ports; and
a valve head biased sealably against the valve seat when the pressure control valve is closed, the valve head having a first area exposed to the first port and defined by the valve seat when the valve is closed and a second area exposed to the second port and defined by the valve seat when the valve is closed and wherein the first port communicates with the second port when the valve is open.

54. The pressure control valve set forth in claim 53 comprising:
a first side of the valve head exposed to a reference pressure;
an opposite second side of the valve head carrying the first and second areas; and
a peripheral edge of the valve head engaged sealably to the body.

55. The pressure control valve set forth in claim 54 wherein the valve head is a resilient diaphragm.

56. The pressure control valve set forth in claim 55 wherein the first area is defined radially between the second area and the peripheral edge.
